(19) United States
(12) Patent Application Publication
(10) Pub. No.: US 2008/0196040 A1
(43) Pub. Date: Aug. 14, 2008

(54) Enterprise clipboard with context

(75) Inventors: Karl Mochel, San Francisco, CA (US); Misha Vaughan, Fremont, CA (US); Patanjali Venkatacharya, Brisbane, CA (US); Hui-ping (Phoebe) Yang, Union City, CA (US); Beth Ann Marx, San Francisco, CA (US)

Correspondence Address: Kraguljac & Kalnay, LLC, 4700 Rockside Road, Summit One, Suite 510, Independence, OH, 44131, US

(73) Assignee: Oracle International Corporation, Redwood Shores, CA (US)

(21) Appl. No.: 11/899,833

(22) Filed: Sep. 7, 2007

Related U.S. Application Data
(60) Provisional application No. 60/901,149, filed on Feb. 14, 2007.

(51) Int. Cl. G06F 3/00

(52) U.S. Cl. 719/316

(57) ABSTRACT

Systems and methods that interact with an enterprise clipboard are described. One example system embodiment includes logic to acquire an object item and logic to acquire information about the object item. The information may be metadata and/or contextual information. The example system embodiment includes logic to create a context associated with the object item. The example system embodiment includes logic to selectively provide to an enterprise clipboard the object item along with information about the object item so that the receiver of the object item and the information about the object item does not receive just data.

### CROSS-REFERENCE TO RELATED APPLICATIONS

This application claims the benefit of U.S. Provisional Application 60/901,149, titled Enterprise Clipboard with Context, filed Feb. 14, 2007.

### BACKGROUND

A member of an enterprise may use a number of enterprise applications to access and process enterprise objects. For example, an enterprise may have an application for handling recruiting, an application for handling payroll, an application for handling purchase orders, and so on. Each of these applications may process its own type of enterprise object that tends to conform to pre-defined configurations associated with the related application and intended usage. Enterprise objects tend to store pre-defined sets of information related in pre-defined ways. These objects tend to belong to the organization (e.g., enterprise) rather than to an individual.

Conventionally it has been difficult, if possible at all, to fluidly transfer enterprise data and/or enterprise objects between different enterprise applications while maintaining any context (e.g., user identity, user role, user business process) associated with the data. Consider the three applications described above, the recruiting, payroll, and purchase order applications. It may have been difficult to transfer data and/or objects between these applications. This has been the case whether a single user is trying to transfer data and/or objects between enterprise applications used by that single user or whether one member of an enterprise is trying to transfer data and/or objects to another member of the enterprise. The recipient of the transferred data often receives “just data” to which the recipient application then applies its own methods.

Additionally, it has been difficult, if possible at all, to fluidly transfer enterprise data to applications that operate on personal objects while maintaining any context associated with the data. A personal object may be, for example, a letter, a spread sheet, a contact, an email, and so on. These objects tend to be less structured and more user-defined than enterprise objects. These objects may contain information acquired from a variety of places that may be inter-related in ad hoc user-defined ways. These objects tend to be processed by personal object processing applications including, for example, word processors, spread sheet applications, drawing applications, and so on. Once again, the receiving application receives “just data” because available context is typically lost during an operation (e.g., cut and paste) when a value is copied from place to place.

To summarize, enterprise applications tend to include logics that operate on enterprise objects. Conventionally, context associated with enterprise data and/or enterprise objects has been lost when the data or objects have been moved from one enterprise application to another enterprise application. Additionally, context associated with enterprise data and/or enterprise objects has been lost when data associated with an enterprise object has been moved from an enterprise application to a personal application.

Enterprise integration applications have attempted to produce more widespread and more sophisticated data sharing for enterprises. However, these enterprise integration applications simply tend to make inert data more widely accessible throughout an enterprise. Other integration tools (e.g., data pipes) may make shared data more live by periodically updating values fed through the pipes. While valuable, the up-to-date data remains simply a disconnected item, an out of context number or string whose essence (e.g., relationships, operations, views, metadata, context) resides with its creating and hosting application.

### BRIEF DESCRIPTION OF THE DRAWINGS

The accompanying drawings, which are incorporated in and constitute a part of the specification, illustrate various example systems, methods, and other embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. In some examples, an element shown as an internal component of another element may be implemented as an external component and vice versa. Furthermore, elements may not be drawn to scale.

Prior Art FIG. 1 illustrates conventional clipboard-based data sharing.

Prior Art FIG. 2 illustrates an enterprise integration server.

FIG. 3 illustrates an example system including an enterprise clipboard.

FIG. 4 illustrates an example system including an enterprise clipboard.

FIG. 5 illustrates an example system including an enterprise clipboard.

FIG. 6 illustrates an example method associated with an enterprise clipboard.

FIG. 7 illustrates an example computing environment in which example systems and methods illustrated herein can operate.

FIG. 8 illustrates an example enterprise clipboard connecting members of a workgroup.

FIG. 9 illustrates an example enterprise clipboard connecting workgroups.

### DETAILED DESCRIPTION

Example systems and methods concern moving items (e.g., data, objects) between enterprise applications via an enterprise clipboard. Example systems and methods capture, create, maintain, and/or provide context. Thus, the enterprise clipboard delivers more than “just data” using the context. While data may be delivered, data about that data, data from an object, methods from an object, and/or an entire object may be provided. Thus, data and/or processes associated with the provider of the items may also be available in the receiving application, making the received data more than just data. In one example, the context may be associated with security and/or synchronization.

An enterprise object may include both data and methods for processing that data. Metadata may describe the enterprise object. The enterprise object will not be used in a vacuum, rather the object will be used in some context. For example, the enterprise object will be processed by a user using an application to perform a task at a place and time. The user may have a certain set of security credentials. Thus, the who, what, where, when, why, and/or how associated with an enterprise object may be described in data available to a capture logic. The capture logic may therefore gather an object, metadata concerning the object, contextual information concerning the object, and so on. A clipboard logic may then selectively process the gathered items and move selected items to an enterprise clipboard that is available to other enterprise applications. The selected items may then be delivered collectively along with the desired data to make the delivered data more than just data. Recall that the clipboard user may have had certain security characteristics. Thus, a receiver of the delivered data may need to exhibit similar or superior characteristics to access the clipboard-provided data and context. In one example, this may include being authenticated.

In one example, enterprise applications to which the items provided to the enterprise clipboard are available are applications used by the user of the provider of the items. In another example, enterprise applications to which the items provided to the enterprise clipboard are associated with different users in the same enterprise workgroup as the provider of the items. In yet another example, the enterprise applications to which the items provided to the enterprise clipboard are available are applications associated with users in workgroups different from the workgroup holding the provider of the items. In still yet another example, the information provided to the enterprise clipboard is available to users of personal object processing applications in the enterprise. In one example, the items provided to the enterprise clipboard may subsequently be used off line by a user. For example, a user may acquire some data and context from the enterprise clipboard and then disconnect from an enterprise network. The user may update the data while disconnected. When the user reconnects to the enterprise network, the data may need to be synchronized. Therefore, part of the context that makes the data more than just data may concern whether the data is currently synchronized.

Context may affect what actions are available to a receiving application. Compare a value received from a traditional clipboard to information available on the enterprise clipboard. A value received from a traditional clipboard is simply a value. It is “just data”. It is a standalone value that carries no information about the context in which it was being used and provides no functionality for how to process the value. Information available on the enterprise clipboard includes not just values but also data about the data on the enterprise clipboard. This data may be metadata (e.g., creation date, creation time, copy time, format, size, synchronization status, security characteristics). This data may also describe context (e.g., user, role, related processes, related analytics, accessing enterprise application, creating enterprise application, related objects). Providing the context and the data about the data facilitates a receiving application providing analytics, actions, methods, and/or information that conventionally may only have been available in the providing enterprise application.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Machine-readable medium”, as used herein, refers to a medium that participates in directly or indirectly providing signals, instructions and/or data. A machine-readable medium may take forms, including, but not limited to, non-volatile media (e.g. ROM, disk) and volatile media (RAM). Common forms of a machine-readable medium include, but are not limited to, a floppy disk, a flexible disk, a hard disk, a magnetic tape, other magnetic medium, a CD-ROM, other optical medium, a RAM, a ROM, an EPROM, a FLASH-EPROM, or other memory chip or card, a memory stick, and other media from which a computer, a processor or other electronic device can read.

“Data store”, as used herein, refers to a physical and/or logical entity that can store data. A data store may be, for example, a table, a file, a list, a memory, a register, and so on. A data store may reside in one logical and/or physical entity and/or may be distributed between two or more logical and/or physical entities.

“Logic”, as used herein, includes but is not limited to hardware, firmware, executable instructions and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing executable instructions, and so on. Logic may include one or more gates, combinations of gates, or other circuit components. Logic may also be fully embodied as executable instructions. Where multiple logical logics are described, it may be possible to incorporate the multiple logical logics into one physical logic. Similarly, where a single logical logic is described, it may be possible to distribute that single logical logic between multiple physical logics.

“Object” is used herein in its computer science term of art usage. Thus, “object”, refers to a single logical entity that includes a collection of data and methods for processing that data. Some data may be public while other data may be private. Similarly, some methods may be public while other methods may be private. Example methods may include constructors, destructors, get/set methods, and so on.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include, differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor executable instructions that can be read, interpreted, and/or executed and that cause a computer, processor, or other electronic device to perform functions, actions and/or behave in a desired manner. The instructions may be embodied in various forms including routines, algorithms, modules, methods, threads, and/or programs. Software may be implemented in a variety of executable and/or loadable forms including, but not limited to, a stand-alone program, a function (local and/or remote), a servelet, an applet, instructions stored in a memory, part of an operating system, and so on. It will also be appreciated that machine-readable and/or executable instructions can be located in one logic and/or distributed between two or more communicating, co-operating, and/or parallel processing logics and thus can be loaded and/or executed in serial, parallel, massively parallel and other manners. Software, whether an entire system or a component of a system, may be embodied as an article of manufacture and maintained or provided as part of a machine-readable medium as defined previously.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here and generally is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and so on.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, calculating, determining, displaying, automatically, and so on, refer to actions and processes of a computer system, logic, processor, or similar electronic device that manipulates and transforms data represented as physical (electronic) quantities.

Prior Art FIG. 1 illustrates conventional clipboard-based data sharing that provides “just data”. A first enterprise application 100 may process a first enterprise object 110. The first enterprise application 100 may create object 110, may manipulate a value 120 associated with object 110, and so on. Context relevant actions and data (e.g., 132 and 134 through 138) may be associated with object 110. A second enterprise application 160 may process a second enterprise object 170. The second enterprise application 160 may create object 170, may manipulate a value 180 associated with object 170, and so on. Context relevant actions and data (e.g., 192 and 194 through 198) may be associated with object 170.

A user may want to copy value 120 to value 180. For example, a user may want to copy a social security number available in a human resources object associated with application 100 to a payroll object associated with application 160. Thus, a copy of value 120 may be moved to clipboard 150 and then to value 180. This copy would be a static (e.g., written once) value that may not retain any information associated with value 120. In one example, some metadata may be provided along with the copy of value 120 provided through clipboard 150. For example, in a clipboard-based DHTML (dynamic hypertext markup language) data transfer, the format of the copied value may be provided. Regardless of how the conventional clipboard transfer occurs, no context associated with value 120, object 110, actions 132 through 138 or application 100 is made available to the clipboard 150 or through the clipboard 150 to application 160. Thus, value 180 is “just data” to application 160. Thus, no additional data and/or actions can be provided to application 160 based on information provided across clipboard 150.

Prior Art FIG. 2 illustrates an enterprise integration server 220 that integrates data from different enterprise object processing applications (e.g., 200 . . . 210) to which server 220 is connected. Enterprise integration server 220 may store enterprise data, enterprise objects, and/or data associated with these types of objects. Enterprise server 220 may also be connected to a personal object processing application 230. Application 230 operates on personal objects, and may even receive some data from enterprise server 220.

Data received from server 220 will be “just data”. For example, a value, a field, or an object provided from application 200 to server 220 and then provided from server 220 to application 210 will be context free data. Use of this data will therefore be limited to the actions available in the receiving application, even though additional actions, information, and/or uses were available in the providing application and even though additional uses may be available based on the context in which the provided data was used in the providing application.

Server 220 may employ techniques including data consolidation, data federation, and/or data propagation to integrate data between enterprise applications. Regardless of the integration technique, the data provided through server 220 will remain “just data”. For example, data consolidation may be performed by a set of processes that capture, cleanse, integrate, transform, and/or load data into a target data store. Context is neither created nor maintained. Data may be consolidated from operational data sources and loaded into data stores including a data warehouse, an operational data store, a data mart, and so on.

Data federation may be performed by a set of processes that provide real-time integrated views of different data types available in different data sources. The integrated view may be provided by a universal data access layer. While this makes more types of data available to more types of applications, the federated data remains “just data”. Data federation typically produces virtual data stores and virtual views of data. Data propagation may be performed by a set of processes that centralize and optimize application integration using, for example, bulk data transfers. Once again, propagated data remains just data.

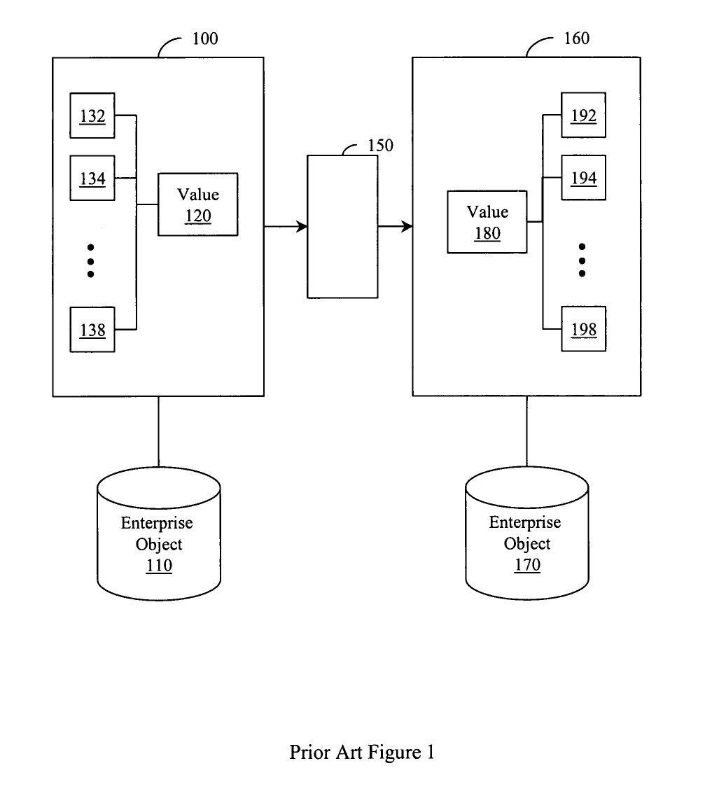

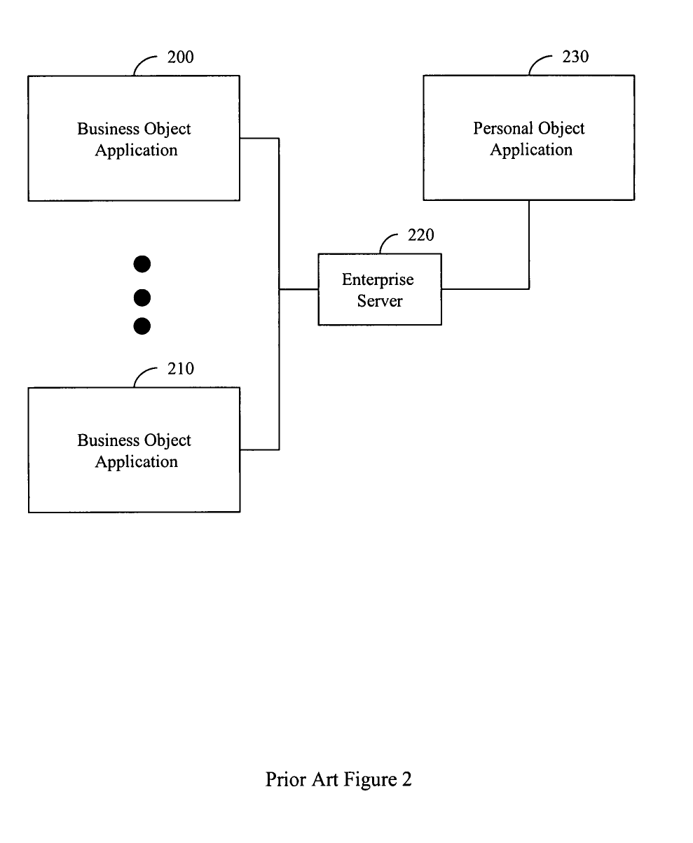

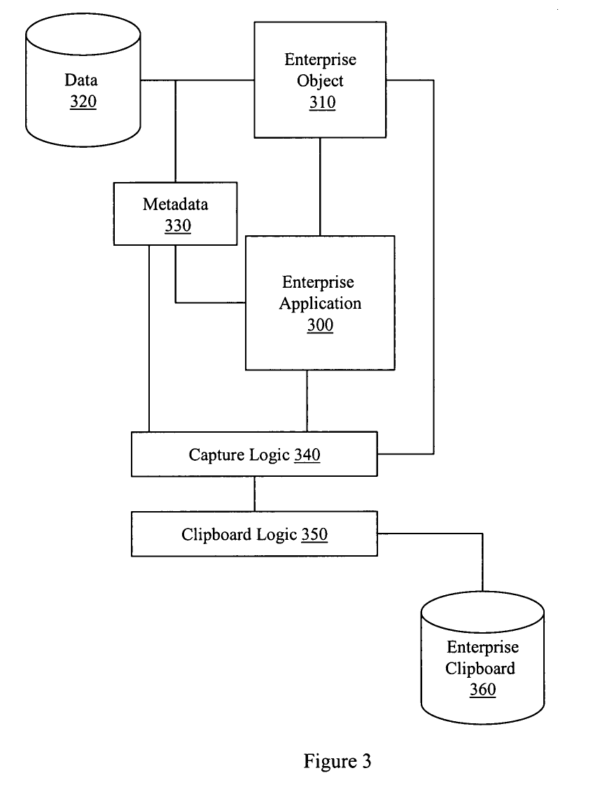

FIG. 3 illustrates an enterprise clipboard 360 operably connected to a clipboard logic 350. An enterprise application 300 may operate on an enterprise object 310. For example, the application 300 may get and set values associated with object 310, may present data stored in object 310, may use data associated with object 310 to make decisions or to produce values for other objects, and so on. Values associated with object 310 may be stored as data 320. While data 320 is illustrated external to object 310, in different examples object 310 may have its own memory in which values are stored, may have pointers to other memory in which values are stored, may have identifiers (e.g., GUID) of data, and so on. Additionally data 320 may represent enterprise data. Information may be available to describe application 300, object 310, and/or data 320. Information may also be available concerning actions associated with the data. This data about data may be stored as metadata 330. Application 300 may be using object 310 to perform some task. Information about the context in which the application 300 is performing the task may be available. The context may include security related information and/or synchronization related information.

A capture logic 340 may capture items including metadata 330 (e.g., information concerning application 300, information concerning object 310, information about data 320, information about the methods), object 310, data 320 associated with object 310, methods associated with object 310, and so on. The metadata 330 may include, for example, a user data (e.g., name=bob smith), a user role (e.g., accountant), a domain (e.g., Midwest group), a business process (e.g., acting as accountant), an enterprise object being worked on (e.g., Midwest accounts receivable), a task (e.g., accounts receivable report generation), an enterprise application being used (e.g., accounts receivable application), a security level associated with application 300, a security level associated with object 310, a security level associated with data 320, and so on. The metadata 330 may also include, for example, data concerning an object access time, an object access date, an object creation time, an object creation date, an object synchronization status, a person accessing the object, a location from which the object is accessed, and so on.

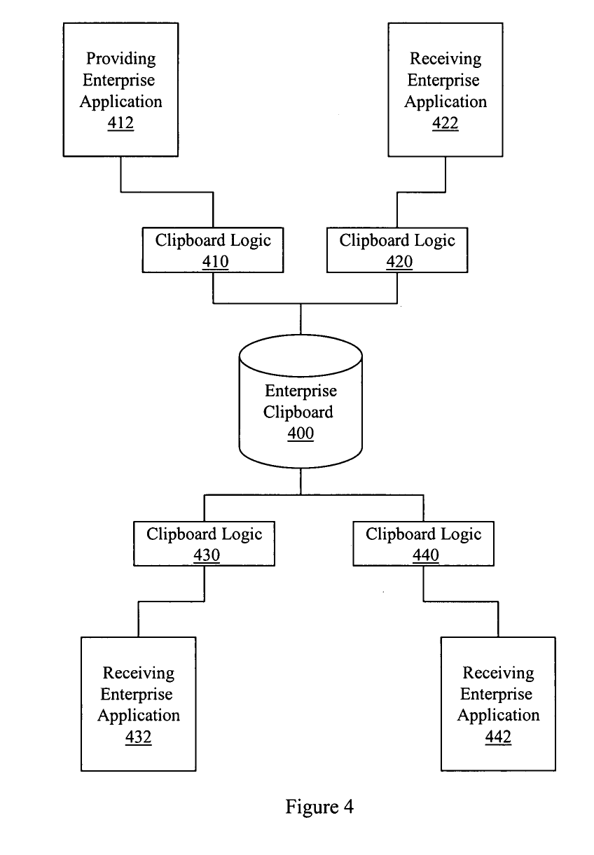

A clipboard logic 350 may then selectively retrieve information from the capture logic 340, selectively create new information, and selectively provide retrieved and/or created information to the enterprise clipboard 360. In one example, the information selected and provided may depend on the receiving application. For example, a first receiving application may have a first set of needs in response to which a first set of information may be provided while a second receiving application may have a second set of needs in response to which a second set of information may be provided. While selectively differential acquisition and provision of information to clipboard 360 by clipboard logic 350 is described, it is to be appreciated that in one example non-selective writing may occur, in which case a receiving application may employ a receiving clipboard logic to select desired information. See, for example, FIG. 4.

Enterprise clipboard 360 may therefore receive data, metadata, contextual information, and so on. The data may be actual data, a copy of data, a link to data, and so on. In one example, the data may be a “visual snapshot” of what was appearing on a compute monitor at a point in time. This snapshot may be referred to as a “screen scrape” and may be analogous to a “print screen” image. Thus the data may be copied data or live data. In one example, the clipboard 360 may receive an entire enterprise object and data (e.g., metadata, context) associated with the object. In another example, the clipboard 360 may receive an object identifier (e.g., globally unique identifier (GUID), uniform resource locator (URL), address) and data (e.g., metadata, context) associated with the object. Thus, rather than simply receiving a value, the clipboard 360 may receive additional items (e.g., metadata, context, methods) concerning a received value. Therefore the clipboard 360 can provide these additional items when it provides a value to a receiving application.

Consider the following situation. A user (e.g., accountant) has some information in a human resources (HR) application. This information may be stored in an enterprise object associated with the HR application. The enterprise object associated with the HR application may store, for example, a name, address, and social security number. The object may also provide methods for selectively getting, setting, displaying, hiding, encrypting, and so on, these data items. The object may be subject to certain security measures. The accountant may want to move some of the information to a payroll application so that a new hire can receive a paycheck. The accountant may also want to move some of the information to an organization chart application so that an organization chart can be updated. Finally, the accountant may want to move some information to a word processing file that stores some information about new hires so that a department newsletter can be prepared. The payroll application may process enterprise objects, the organization chart application may process enterprise objects, and the department newsletter may be a personal object.

To accomplish these tasks, the accountant may make the HR enterprise object and information (e.g., metadata, context) about the enterprise object available on the enterprise clipboard. Then each of the receiving applications can acquire desired information from the clipboard. This information will be acquired in light of the context in which it was produced, used, and/or provided. For example, since an accountant acting as an accountant provided the HR object to the clipboard, a first set of data associated with the object may be available whereas if a secretary acting as a secretary provided the HR object to the clipboard a second (e.g., more restricted) set of information may be available. The receiving application may choose to receive the entire object (if available), a portion of the object, a subset of the information available on the clipboard, and so on. The receiving application will receive this information and may choose to receive the metadata and/or contextual information concerning the data. To receive the data, a user may need to satisfy certain security measures (e.g., authentication). Compare this retrieval to a traditional clipboard transfer where just a copy of data would be available. Compare this retrieval also to other conventional transfer methods (e.g., email, wiki, blog) where data is provided but nothing else.

FIG. 4 illustrates an example enterprise clipboard 400 in data communication with a number of clipboard logics (e.g., 410, 420, 430, 440) that are in turn operably connected to a number of applications (e.g., 412, 422, 432, 442). In FIG. 4, application 412 is identified as a providing enterprise application from which items will be moved to the clipboard 400 and then to other applications. Applications 422, 432, and 442 are identified as receiving enterprise applications. Thus FIG. 4 illustrates enterprise application to enterprise application data communication. Unlike conventional systems that would provide “just data” through enterprise data integration or other means, clipboard 400 can receive data, an object data, an object method, an object, metadata, and information from which context can be created, maintained, used, and/or provided. Rather than simply receive a data value, clipboard 400 can receive from logic 410 both data and information to facilitate maintaining a relationship between the data and the context in which it was created, used, and so on.

Thus, a receiving enterprise application (e.g., 422) can receive more than just data. A receiving enterprise application may receive data and related information (e.g., metadata, context, methods) from clipboard 400. For example, a receiving enterprise application may receive data, an object data, an object method, an object, metadata, context, and information from which context can be created, maintained, and/or used. Receiving the data and information may include, for example, receiving a value, receiving a pointer, receiving an identifier, receiving an address, receiving computer executable instructions, and so on.

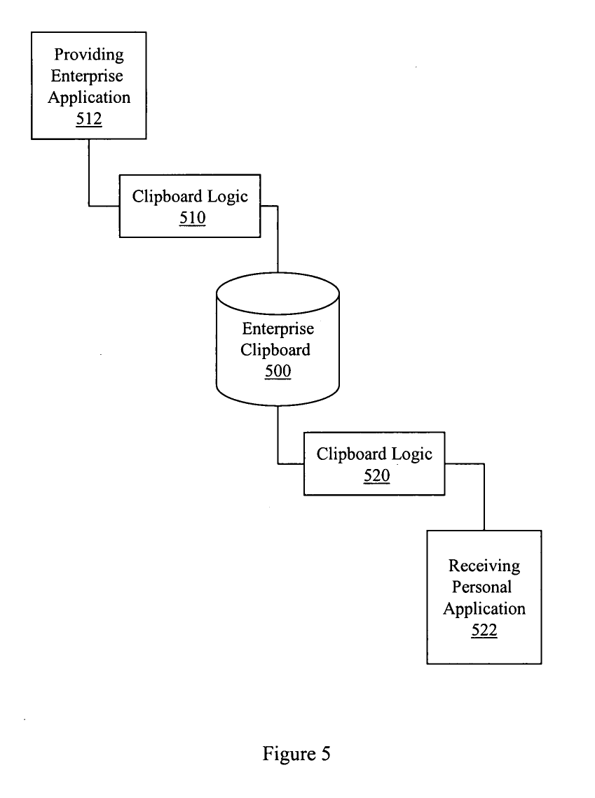

FIG. 5 illustrates an enterprise clipboard 500 in data communication through clipboard logics 510 and 520 with a providing enterprise application 512 and with a receiving personal application 522 respectively. Once again, the providing application 512 can provide, through logic 510, more than just data. For example, data, object data, object methods, objects, data concerning these items, and contextual information (e.g., user, role, task) can be provided to clipboard 500 by logic 510. The provided item(s) may be protected by some security characteristics. Logic 520 may select more than just a piece of data to provide to a receiving personal application 522. For example, logic 520 may select both a piece of data and executable instructions for keeping that data live, executable instructions for displaying that data in different formats, executable instructions for encrypting that data according to an algorithm associated with application 512, and so on. Therefore, receiving application 522 can do more than simply copy in and display the value. Receiving application 522 can receive the data and the computer executable instructions, use the received computer executable instructions to manipulate the data, and, in one example, when the receiving application 522 and providing application 512 share an address space, may even use the received computer executable instructions to manipulate data “owned” by the providing application. Receiving the data and/or computer executable instructions may include receiving the items, receiving copies of the items, receiving pointers to the items, receiving item identifiers (e.g., GUID), and so on. In one example, the receiving application 522 and/or a user thereof may need to satisfy the associated security characteristics.

Example methods may be better appreciated with reference to flow diagrams. While for purposes of simplicity of explanation, the illustrated methods are shown and described as a series of blocks, it is to be appreciated that the methods are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methods can employ additional, not illustrated blocks. While the figures illustrate various actions occurring in serial, it is to be appreciated that in some examples various actions could occur concurrently, substantially in parallel, and/or at substantially different points in time. In one example, blocks may represent executable instructions that cause a computer, processor, and/or logic device to respond, to perform an action(s), to change states, and/or to make decisions. Thus, the described methods can be implemented as processor executable instructions and/or operations provided by a machine-readable medium. In another example, blocks may represent functions and/or actions performed by functionally equivalent circuits including an analog circuit, a digital signal processor circuit, an application specific integrated circuit (ASIC), or other logic device.

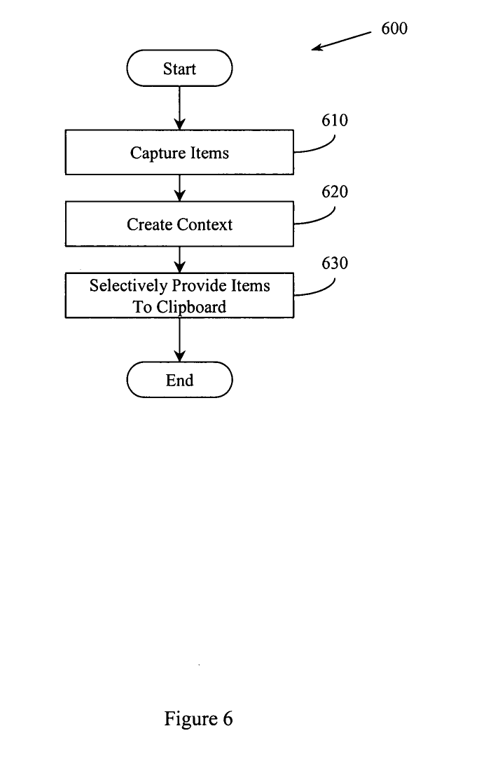

FIG. 6 illustrates a method 600 associated with an enterprise clipboard for transferring data and items associated with the data, where the transferring depends, at least in part, on the context of the provider of the data and items. Method 600 may include, at 610, capturing items associated with an enterprise object, enterprise data, and/or an enterprise application processing the enterprise object and/or data.

In one example, enterprise object metadata may be captured. The enterprise object metadata may include data identifying a set of actions available to process the enterprise object. For example, business processes and analytics may be available for an enterprise object, thus the enterprise metadata may include data identifying these actions and/or providing paths (e.g., addresses, links, pointers) to machine executable instructions to perform the actions.

Capturing the data may include, for example, reallocating a memory location, acquiring a pointer to a memory location, acquiring a copy of the contents of a memory location, acquiring an identifier of a related set of memory locations (e.g., GUID), and so on.

Method 600 may also include, at 620, creating a context associated with the captured items and the environment in which they were captured, used, and/or will be used. The context facilitates identifying, for example, who was processing an object, what object was being processed, from where it was being processed, when it was being processed, and/or how it was being processed. Thus, the context may include a user identifier, a user security metadata, a user task, a user role, and so on. The context may also include, for example, synchronization data.

The context facilitates identifying what data and/or actions associated with an enterprise object may be made available to a receiving application through an enterprise clipboard. Having created a context and having determined data, methods, and/or information to be provided to an enterprise clipboard, method 600 may include, at 630, selectively providing to the enterprise clipboard the set of selected items. Which items are provided will depend on the context created at 620. Providing the selected items to the enterprise clipboard may include, for example, reallocating memory, providing a pointer to a memory location(s), providing a copy of the contents of a memory location, providing an identifier (e.g., GUID), and so on.

In one example, methods are implemented as processor executable instructions and/or operations stored on a machine-readable medium. Thus, in one example, a machine-readable medium may store machine executable instructions operable to perform method 600. It is to be appreciated that other machine executable example methods described herein can also be stored on a machine-readable medium.

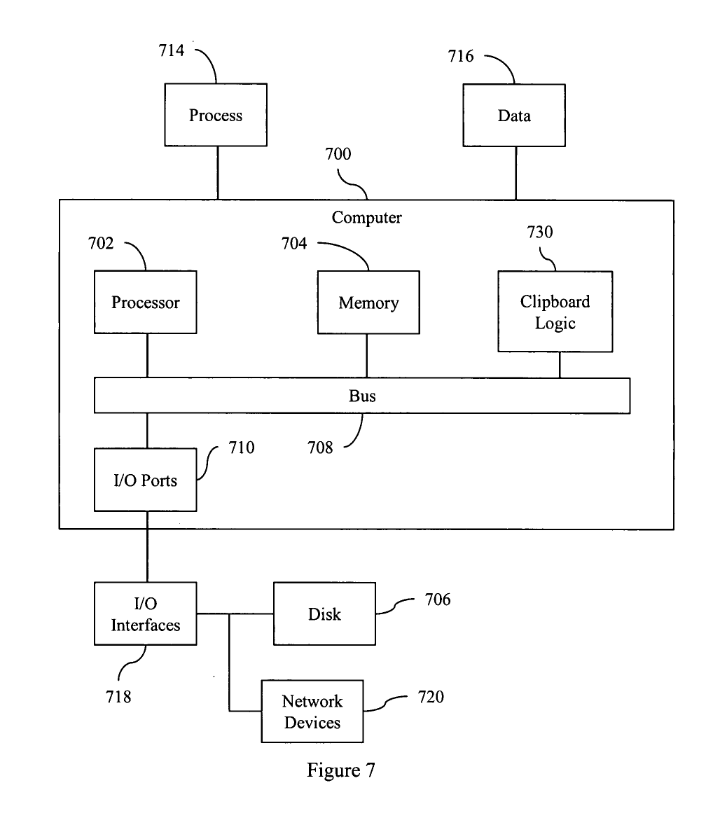

FIG. 7 illustrates an example computing device in which example systems and methods described herein, and equivalents, can operate. The example computing device may be a computer 700 that includes a processor 702, a memory 704, and input/output ports 710 operably connected by a bus 708. In one example, the computer 700 may include a clipboard logic 730 configured to facilitate capturing items associated with an enterprise data, object, and/or application, and then selectively providing captured items and/or information derived from the captured items to an enterprise clipboard. Thus, clipboard logic 730 may include means (e.g., hardware, executable instructions, firmware) for capturing an enterprise object and information related to the enterprise object. Clipboard logic 730 may also include means (e.g., hardware, executable instructions, firmware) for creating a set of data that describes the enterprise object and/or its uses. Clipboard logic 730 may also include means (e.g., hardware, executable instructions, firmware) for selectively providing items to a clipboard based, at least in part, on the context.

Generally describing an example configuration of the computer 700, the processor 702 can be a variety of various processors including dual microprocessor and other multi-processor architectures. The memory 704 can include volatile memory and/or non-volatile memory. The non-volatile memory can include, but is not limited to, ROM, PROM, EPROM, EEPROM, and so on. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 706 may be operably connected to the computer 700 via, for example, an input/output interface (e.g., card, device) 718 and an input/output port 710. The disk 706 can include, but is not limited to, a magnetic disk drive, a solid state disk drive, a floppy disk drive, a tape drive, a Zip drive, a flash memory card, and/or a memory stick. Furthermore, the disk 706 can include optical drives including a CD-ROM, a CD recordable drive (CD-R drive), a CD rewriteable drive (CD-RW drive), and/or a digital video ROM drive (DVD ROM). The memory 704 can store processes 714 and/or data 716, for example. The disk 706 and/or memory 704 can store an operating system that controls and allocates resources of the computer 700.

The bus 708 can be a single internal bus interconnect architecture and/or other bus or mesh architectures. While a single bus is illustrated, it is to be appreciated that computer 700 may communicate with various devices, logics, and peripherals using other busses that are not illustrated (e.g., PCIE, SATA, Infiniband, 1394, USB, Ethernet). The bus 708 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 700 may interact with input/output devices via i/o interfaces 718 and input/output ports 710. Input/output devices can include, but are not limited to, a keyboard, a microphone, a pointing and selection device, cameras, video cards, displays, disk 706, network devices 720, and so on. The input/output ports 710 can include but are not limited to, serial ports, parallel ports, and USB ports.

The computer 700 can operate in a network environment and thus may be connected to network devices 720 via the i/o interfaces 718, and/or the i/o ports 710. Through the network devices 720, the computer 700 may interact with a network. Through the network, the computer 700 may be logically connected to remote computers. The networks with which the computer 700 may interact include, but are not limited to, a local area network (LAN), a wide area network (WAN), and other networks. The network devices 720 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and so on. Similarly, the network devices 720 can connect to WAN technologies including, but not limited to, point to point links, circuit switching networks (e.g., integrated services digital networks (ISDN)), packet switching networks, and digital subscriber lines (DSL).

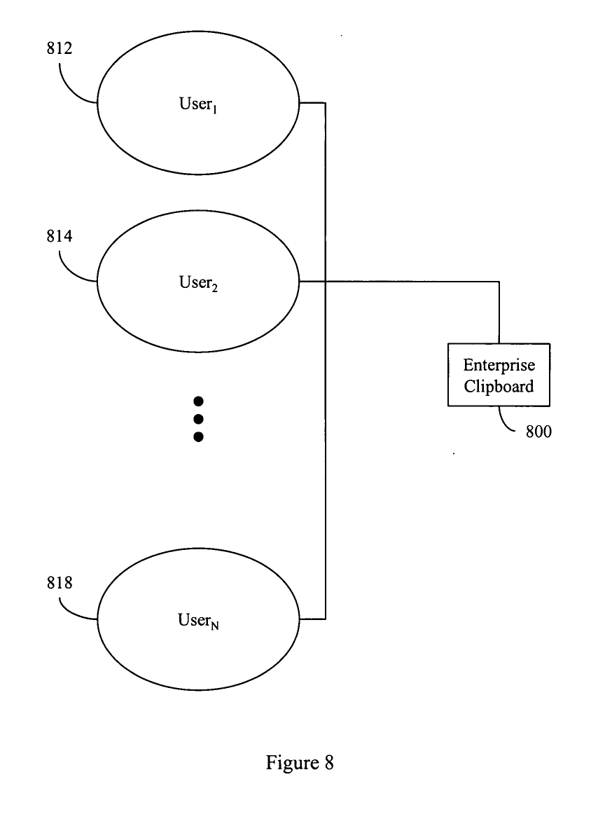

FIG. 8 illustrates an enterprise clipboard 800 with which a set of users (e.g., 812 and 814 through 818) may interact. The set of users may form, for example, a workgroup. User, 812 may use a set of enterprise applications like those described in connection with FIG. 4 to process a set of enterprise objects. Similarly, User₂ 814 through User_{N} 818 may each use sets of enterprise applications to process sets of enterprise objects. Thus, enterprise clipboard 800 may transfer data, object data, object methods, objects, metadata, and contextual information between workgroup members.

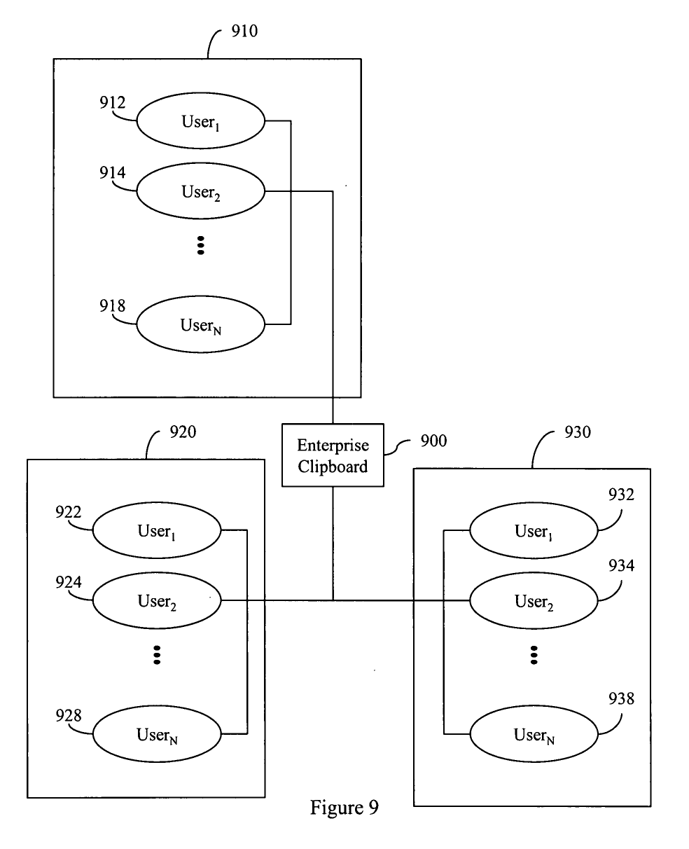

FIG. 9 illustrates an enterprise clipboard 900 with which a set of workgroups (e.g., 910, 920, 930) may interact. While three workgroups are illustrated, it is to be appreciated that a greater and/or lesser number of workgroups may interact with an enterprise clipboard. A first workgroup 910 may include users 912 and 914 through 918. Similarly a second workgroup 920 may include users 922 and 924 through 928 while a third workgroup 930 may include users 932 and 934 through 938. Users may interact with sets of enterprise objects using sets of enterprise applications. Thus, enterprise clipboard 900 may transfer data, object data, object methods, objects, metadata, and contextual information between different workgroups. Whether data can be transferred and/or received may depend, for example, on authentication based security.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A system, comprising:
an enterprise clipboard data store to store and provide an object item and information related to the object item;
a capture logic to capture the object item, to capture metadata concerning the object item, and to capture contextual information concerning the object item, the object item being an item selected to provide to the enterprise clipboard data store; and
a clipboard logic operably connected to the capture logic, the clipboard logic to create a context concerning the object item, the context to be created from the metadata concerning the object item and the contextual information concerning the object item,
the clipboard logic to selectively provide to the enterprise clipboard data store the object item, and one or more of, a subset of the metadata, a subset of the contextual information, and a subset of the context.

2. The system of claim 1, the object item being one of, an object data, an object method, and an object.

3. The system of claim 2, the metadata comprising data describing one or more of, an enterprise application that created the object item, an enterprise application that used the object item, a set of actions available in an enterprise application to process the object item, a freshness associated with the object item, a creation time associated with the object item, an object item format, an object item size, an access time associated with the object item, an access date associated with the object item, and a synchronization identifier associated with the object item.

4. The system of claim 2, the contextual information comprising one or more of, an object item user identifier, an object item user name, an object item user security credential, an object item user task, an object item user role, an object item user workgroup, an object item user domain, a set of analytics available for the object item, objects to which the object item refers, objects that refer to the object item, and a location of the object item user.

5. The system of claim 1, where to capture the object item the capture logic is to cause one or more of, the object item, a copy of the object item, a pointer to the object item, and an identifier of the object item to be moved into memory allocated to the capture logic.

6. The system of claim 5, the identifier of the object item being one of, a globally unique identifier (GUID), a uniform resource locator (URL), an address, and a link.

7. The system of claim 1, where to provide the subset of the object item the enterprise clipboard data store is to cause one or more of, the object item, a copy of the object item, a pointer to the object item, and an identifier of the object item to be moved into memory allocated to the enterprise clipboard data store.

8. The system of claim 7, the identifier of the object item being one of, a globally unique identifier (GUID), a uniform resource locator (URL), an address, and a link.

9. The system of claim 1, the clipboard logic to select an item to provide to the enterprise clipboard data store based, at least in part, on the context.

10. The system of claim 9, where the context includes data describing a receiver of the object item.

11. The system of claim 1, the clipboard logic being associated with a providing enterprise application, the enterprise clipboard data store being read by a receiving enterprise application associated with a user of the providing enterprise application.

12. The system of claim 1, the clipboard logic being associated with a providing enterprise application, the enterprise clipboard data store being read by a receiving enterprise application associated with a second user, the second user being a user other than the user of the providing enterprise application, the second user being a member of a workgroup that includes the user of the providing enterprise application.

13. The system of claim 1, the clipboard logic being associated with a providing enterprise application, the enterprise clipboard data store being read by a receiving enterprise application associated with a second user, the second user being a user other than the user of the providing enterprise application, the second user being a member of a workgroup that does not include the user of the providing enterprise application.

14. The system of claim 1, the clipboard logic being associated with a providing enterprise application, the enterprise clipboard data store being read by a receiving personal object processing application.

15. A machine-readable medium having stored thereon machine-executable instructions that if executed by a machine cause the machine to perform a method, the method comprising:
capturing an object item, metadata concerning the object item, and contextual information concerning the object item;
creating a context from the metadata and the contextual information, the context describing the object item and the use of the object item; and
selectively providing, based at least in part on the context, the object item and an object information to an enterprise accessible data store.

16. The machine-readable medium of claim 15, the object item being one of, an object, an object data, and an object method.

17. The machine-readable medium of claim 16, the object information being one or more of, a subset of the metadata, a subset of the contextual information, and a subset of the context.

18. The machine-readable medium of claim 17, the metadata including data describing a set of actions related to the object item, data describing an object item size, data describing an object item format, data describing an object item logical organization, data describing an object item security characteristic, and data describing an object item physical organization.

19. The machine-readable medium of claim 18, the contextual information including data describing an enterprise application associated with the object item, a user associated with the object item, a user role associated with the object item, and a task associated with the object item.

20. A system, comprising:
means for capturing an enterprise object to be provided to a receiving enterprise application;
means for capturing information related to the enterprise object;
means for creating a set of data that describes the enterprise object, the use to which the enterprise object is put, and the circumstances of the use of the enterprise object; and
means for selectively providing the enterprise object and a subset of the set of data to a data store that is accessible to the receiving enterprise application.
